(19) United States
(12) Patent Application Publication
(10) Pub. No.: US 2004/0068397 A1
(43) Pub. Date: Apr. 8, 2004

(54) Method and apparatus for simulating tire performance, and recording medium

(75) Inventor: Yasuo Ohsawa, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: BRIDGESTONE CORPORATION

(21) Appl. No.: 10/261,485

(22) Filed: Oct. 2, 2002

(51) Int. Cl. G06G 7/48

(52) U.S. Cl. 703/8

(57) ABSTRACT

A method of simulating tire performance of the present invention includes the steps of: (a) preparing a tire model by dividing a patterned tire, which includes a pattern formed from a plurality of land portions, into plural parts, and expressing each part by a part model formed from a large number of divisional elements, and combining a plurality of the part models; (b) expressing a suspension as a suspension model formed from a large number of divisional elements; and (c) analyzing performance of the patterned tire in a state in which the patterned tire is in use, by using, as one numerical computational model, a first numerical computational model including the tire model and a second numerical computational model including the suspension model. In accordance with the present invention, when simulating tire performance, creation of a model and change between plural patterns can be easily performed.

### BACKGROUND OF THE INVENTION

1. Field of the Invention

The present invention relates to a method and apparatus for simulating tire performance, and to a recording medium. In particular, the present invention relates to a method and apparatus for simulating tire performance which can analyze the performance of a patterned tire in a state in which the patterned tire is in use, and to a recording medium which is readable by a computer and on which is recorded a program or the like which analyzes the performance of a patterned tire in a state in which the patterned tire is in use.

2. Description of the Related Art

Conventionally, when attempts are made to predict and improve the noise, the vibration and the ride comfort of a tire, experiments are carried out on a tire as a unit in itself.

However, usually, in a testing machine which tests an actual tire itself as a unit, the region where the wheel is mounted is fixed to the testing machine. This is fundamentally different than a case in which the tire mounting region (i.e., the suspension) is movable, which is the case when the tire is actually mounted to a vehicle. Thus, it is difficult to accurately measure small differences in tire performance when the tire pattern is changed. Namely, in a testing machine which tests an actual tire as a unit, it is difficult to accurately measure the effects at the time of changing the pattern of a patterned tire whose pattern is formed from a plurality of land portions, and in particular, a patterned tire which includes lug grooves, sipes, near-circumferential-direction-lug grooves (i.e., the lug groove having a higher angle with respect to the tire lateral direction), and the like.

In order to overcome this problem, a suspension is mounted to the testing machine which tests an actual tire as a unit. However, in this case, there is the problem that it is difficult to make the geometrical position of the suspension closely correspond to the vehicle. There is also the problem that a large number of suspensions must be prepared to correspond to various types of suspensions.

Moreover, when testing is carried out by actually mounting a tire to a vehicle, four tires and the vehicle must be prepared. In this case, as the vehicle and the tires inevitably move together (translation motion) at the time of testing, problems arise in that measurement is extremely difficult, and time and cost-consuming.

Numerical analysis can be carried out in order to overcome these problems. However, in order to analyze the noise within the vehicle, the vibration or the ride comfort of the vehicle seat, analysis must be carried out with the tires mounted to an actual vehicle and by taking the tire pattern into consideration.

Japanese Patent Application Laid-Open (JP-A) No. 11-153520 discloses a simulation method in which simulation is carried out by expressing a patterned tire, whose pattern is formed from a plurality of land portions, by a tire body portion element model and a tread pattern portion element model. However, simulation of a state in which the tire is mounted to a vehicle cannot be carried out.

Further, the technologies disclosed in following publications (1) through (3) are known as methods of simulation which combine the vehicle and the tire: (1) Vehicle Dynamics Simulations with Coupled Multibody and Finite Element Models, C. W. Mousseau, T. A. Laursen, M. Lidberg and R. L. Taylor, Finite Elements in Analysis and Design, 31, [1999] 295-315; (2) Simulation of an Automobile Riding-Over a Step by using an FE model Tire Model (Kimihiro Hayashi, Japan LS-DYNA User Conference '99); (3) ADAMS Tire Analysis by Mechanical Dynamics, Inc. (URL: http://www.adams.co.jp).

However, the techniques of above (1) through (3) do not consider the actual tire pattern of a structure (although these techniques somehow consider a state in which the tire is mounted to a vehicle). The technology of above (3) can somehow carry out simulation in which the equivalent rigidity of a pattern is included in a smooth tire. However, an actual tire pattern is not included in the simulation of the technology (3).

Moreover, in the case of a patterned tire (and in particular, a tire including lug grooves, sipes, near-circumferential-direction-lug grooves, and the like), when numerical computation which combines computation relating to the tire and computation relating to the vehicle is carried out, the numerical computational model becomes large, and it is difficult to construct a model. Further, in order to analyze the effects of patterns on tire performance, an analysis model which allows easy change between a plurality of patterns is needed.

### SUMMARY OF THE INVENTION

The present invention was developed in order to overcome the above-described problems, and an object of the present invention is to provide a method and apparatus for simulating tire performance in which it is easy to prepare a model and it is easy to change between a plurality of patterns, and to provide a recording medium on which a tire performance simulation program is recorded.

In order to achieve the above object, a first aspect of the present invention is a method of simulating tire performance, comprising the steps of: (a) preparing a tire model by dividing a patterned tire, which includes a pattern formed from a plurality of land portions, into plural parts, and expressing each part by a part model formed from a large number of divisional elements, and combining a plurality of the part models; (b) expressing a suspension as a suspension model formed from a large number of divisional elements; and (c) analyzing performance of the patterned tire in a state in which the patterned tire is in use, by using, as one numerical computational model, a first numerical computational model including the tire model and a second numerical computational model including the suspension model.

A second aspect of the present invention is an apparatus for simulating tire performance, comprising: first storing means for storing a first numerical computational model and a second numerical computational model, the first numerical computational model including a tire model prepared by dividing a patterned tire, which includes a pattern formed from a plurality of land portions, into plural parts, and expressing each part by a part model formed from a large number of divisional elements, and combining a plurality of the part models, and the second numerical computational model including a suspension model which expresses a suspension as a model formed from a large number of divisional elements; second storing means for storing a program for analyzing performance of the patterned tire in a state in which the patterned tire is in use; and analyzing means for analyzing, in accordance with the program, performance of the patterned tire in a state in which the patterned tire is in use by using, as one numerical computational model, the first numerical computational model and the second numerical computational model stored in the first storing means.

A third aspect of the present invention is a recording medium readable by a computer, wherein a first numerical computational model including a tire model prepared by dividing a patterned tire, which includes a pattern formed from a plurality of land portions, into plural parts, and expressing each part by a part model formed from a large number of divisional elements, and combining a plurality of the part models; a second numerical computational model including a suspension model which expresses a suspension as a model formed from a large number of divisional elements; and a program for analyzing performance of the patterned tire in a state in which the patterned tire is in use by using, as one numerical computational model, the first numerical computational model and the second numerical computational model, are recorded on the recording medium.

The present invention simulates performance of a patterned tire, in a state in which the patterned tire is in use, by: preparing a patterned tire model, which includes a pattern formed from a plurality of land portions (in particular, lug grooves, sipes, near-circumferential-direction-lug grooves), as a numerical computational model such as, a finite element model (FE model) or the like; also preparing a vehicle body model, including the suspension, as a numerical computational model (e.g., an FE model); and combining these numerical models and analyzing the combined numerical models as one numerical computational model.

In the present invention, at the time of preparing a large-scale numerical computational model, each part, e.g., the pattern and the main body of tire, the tire and the wheel, the suspension arm and the bush, and the like is modeled, and the modeled parts are then combined. In this way, a model to be analyzed, which allows easy change in the pattern thereof, can be prepared efficiently.

As the pattern is a combination of a plurality of land portions, the above-described method naturally includes the steps of regarding respective land portions as respective “members” and combining such land-portion members to obtain a model.

If numerical analysis combining a vehicle and patterned tires which have a pattern formed from a plurality of land portions (in particular, a tire having lug grooves, sipes, near-circumferential-direction-lug grooves, and the like), is carried out, the tire mounting portion is the suspension, which is movable. Thus, the state in which the tire is mounted on a vehicle can be easily recreated, and small differences in the tire performance at the time of changing the pattern can be accurately analyzed. Further, the geometrical position of the suspension can be made to accurately match the vehicle, and therefore, the present invention can easily address various types of suspensions.

The tire model of the present invention can be prepared by dividing a patterned tire into plural parts, and combining a plurality of part models which are each formed by dividing a part into a large number of elements. Thus, when preparing a numerical computational model which is an analysis model, the numerical computational model can be costructed by preparing a model for each individual part and combining these models. Thus, even a large-scale model can be prepared easily in a short period of time.

The first numerical computational model can be made to further include a wheel model which is formed by dividing a wheel into a large number of elements. By combining the wheel model and the tire model, a model of a tire-wheel assembly can be prepared. Further, the second numerical computational model may be made to include, in addition to the suspension model, a vehicle body model formed by dividing a vehicle body into a large number of elements.

The tire may be divided into two parts which are the pattern and the main body of tire which is the portion other than the pattern. A part model, which is formed by dividing the main body of tire into a large number of elements, and a part model, which is formed by dividing the pattern into a large number of elements, can be prepared. Plural types can be prepared for each part model, and a tire model can be prepared by combining a selected one part model for the main body of tire and selected part model(s) for the pattern. In this way, it is possible to efficiently analyze models combining different main bodies of tires and different patterns. Further, the pattern can be changed easily. Note that, when analyzing tires of the same size, it suffices to prepare a single standard model for the part model of the main body of tire.

Further, the pattern can be divided in to a plurality of land portions, regarding each land portion as a member. Then, each land-portion member can be divided into a number of elements, to form a model of the land-portion member. A plurality of models different in type may be prepared for each land-portion-member model. A pattern model can be formed by selecting one model from each land-portion-member model and combining the selected models. That is, pattern models of different types can efficiently be provided. Any of the obtained pattern models can be combined with the aforementioned tire models, whereby the model analysis thereof can be effected. In short, in this case, the pattern model can be easily changed.

Further, a “tire-wheel assembly model” can be prepared by preparing plural types of wheel models, separately from the tire models, and by combining a selected one tire model and a selected one wheel model. In this case, performances of combined structures, in which different types of tires and different types of wheels are combined, can be analyzed efficiently.

Further, performance can be predicted efficiently by combining the “tire-wheel assembly model” with a suspension model which is prepared separately from the “tire-wheel assembly model”, or by further combining a vehicle body model therewith.

When preparing a large-scale numerical computational model, each individual part, e.g., a pattern and a case, a tire and a wheel, a suspension arm and a bush, and the like, is made into a model, and the models are then combined. Thus, a model to be analyzed, which allows easy change in the pattern thereof, can be prepared efficiently.

### BRIEF DESCRIPTION OF THE DRAWINGS

FIG. 1 is a diagram schematically showing an example of a computer used for implementing the present invention.

FIG. 2 is a schematic diagram showing a tire model used in the embodiment of the present invention.

FIG. 3 is a flowchart showing a tire performance simulation processing routine of the embodiment of the present invention.

FIG. 4 is a schematic diagram showing an analysis object model of the embodiment of the present invention, in which three models, which are a vehicle body model, a suspension model, and a “tire-wheel assembly model”, are joined.

FIG. 5 is a schematic diagram showing an analysis object model in which the suspension model and the “tire-wheel assembly model” are joined without the vehicle body model.

FIG. 6 is a schematic diagram showing an analysis object model in which are joined the “tire-wheel assembly model” and a mechanism analysis model of a vehicle (a mechanism analysis model which considers the vehicle body and the suspension structural parts to be rigid bodies, and takes into consideration only the geometrical movement thereof).

FIG. 7 is a schematic diagram showing an analysis object model in which are joined the “tire-wheel assembly model” and a mechanism analysis model which expresses the suspension (a mechanism analysis model which considers the suspension structural parts to be rigid bodies, and takes into consideration only the geometrical movement thereof), without the vehicle body model.

FIG. 8 is a schematic view of a case where simulation is carried out by using a model in which the suspension model and the “tire-wheel assembly model” are joined without the vehicle body model, and by using other results as data of the locus of suspension mounting points.

FIG. 9 is a plan view of a portion of a tread of a tire used in Example 5.

FIG. 10A is a plan view of a portion of a tread of a tire used in Example 6.

FIGS. 10B and 10C are cross-sectional views taken along line 1-1 of FIG. 10A.

FIG. 11A is a plan view of a portion of a tread of a tire used in Example 7.

FIG. 11B(i) is a cross-sectional view, taken along line 2-2 of FIG. 11A, of one tire among the two types of tires used in Example 7, and FIG. 11B(ii) is a cross-sectional view, taken along line 3-3 of FIG. 11A, of that same tire.

FIG. 11C(i) a cross-sectional view, taken along line 2-2 of FIG. 11A, of the other tire among the two types of tires used in Example 7, and FIG. 11C(ii) is across-sectional view, taken along line 3-3 of FIG. 11A, of that same tire.

### DESCRIPTION OF THE PREFERRED EMBODIMENTS

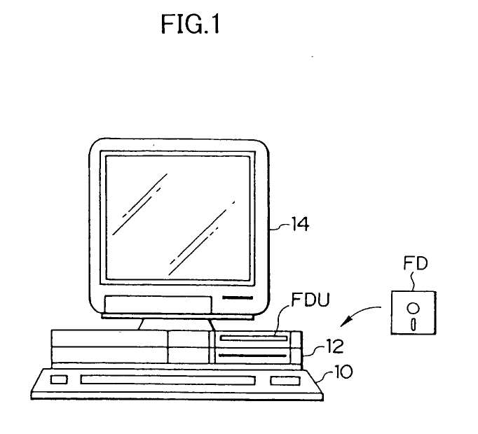

Hereinafter, an embodiment of the present invention will be described in detail with reference to the drawings. As shown in FIG. 1, an apparatus for simulating tire performance of the present embodiment is formed from a computer, and a floppy disk FD which serves as a recording medium and on which is recorded a tire performance simulation program comprised of a tire performance analysis program and a numerical computational model of a tire and a suspension.

The computer is formed from a keyboard 10 for input of data or the like, a computer main body 12 which simulates tire performance in accordance with a processing program which is stored in advance on a recording medium provided at the interior of the computer main body 12, and a display device 14 such as a CRT or the like which displays the results of simulation of the computer main body 12 and the like.

The computer main body 12 is equipped with a floppy disk drive unit (FDU) which the floppy disk FD, which serves as a recording medium, can be inserted into and removed from. A processing routine, which will be described later, and the like can be read from the floppy disk FD by using the FDU. Accordingly, the processing routine which will be described later may be recorded in advance onto the FD, so that a processing program which is recorded on the FD can be executed via the FDU. Alternatively, a mass storage device (not shown) such as a hard disk device or the like may be connected to the computer main body 12, so that the processing program recorded on the FD may be stored in (installed into) the mass storage device and executed. Examples of the recording medium include mass storage magnetic disks such as Zip (trade name) or Jazz (trade name) or the like, optical disks such as a CD-ROM or the like, and magneto-optical disks such as a MO or the like. If such media are used, it suffices to use, in place of or in addition to the FDU, a mass storage magnetic disk device, a CD-ROM device, a MO device, or the like.

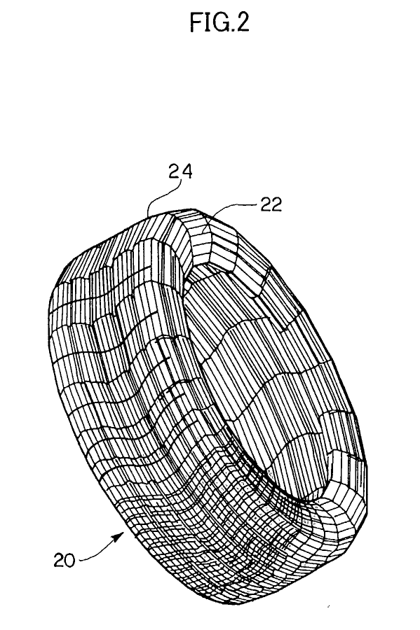

Next, a tire model, which is expressed by a finite element method, of the present embodiment will be described with reference to FIG. 2. As shown in FIG. 2, a tire model 20 is constructed by joining a tire-main-body model 22 and a tread pattern model 24. The tire-main-body model 22 and the tread pattern model 24 are prepared by dividing a patterned tire, which has a pattern formed from a plurality of land portions, into a main body of tire and a tread pattern portion, and by expressing each of the main body of tire and the tread pattern portion by finite elements as a large number of divisional elements of the main body of tire or the tread pattern portion.

A plurality of tire-main-body models 22 and tread pattern models 24 are constructed in accordance with the types of tires, and are recorded onto a recording medium within the computer.

On the recording medium are recorded a plurality of wheel models which are prepared by dividing each of plural types of tire wheels into a large number of elements, a plurality of suspension models which are prepared by dividing each of plural types of suspensions into a large number of elements, a plurality of vehicle body models which are prepared by dividing each of plural types of vehicle bodies into a large number of elements, a plurality of mechanism analysis models of a vehicle, and a plurality of mechanism analysis models of a suspension.

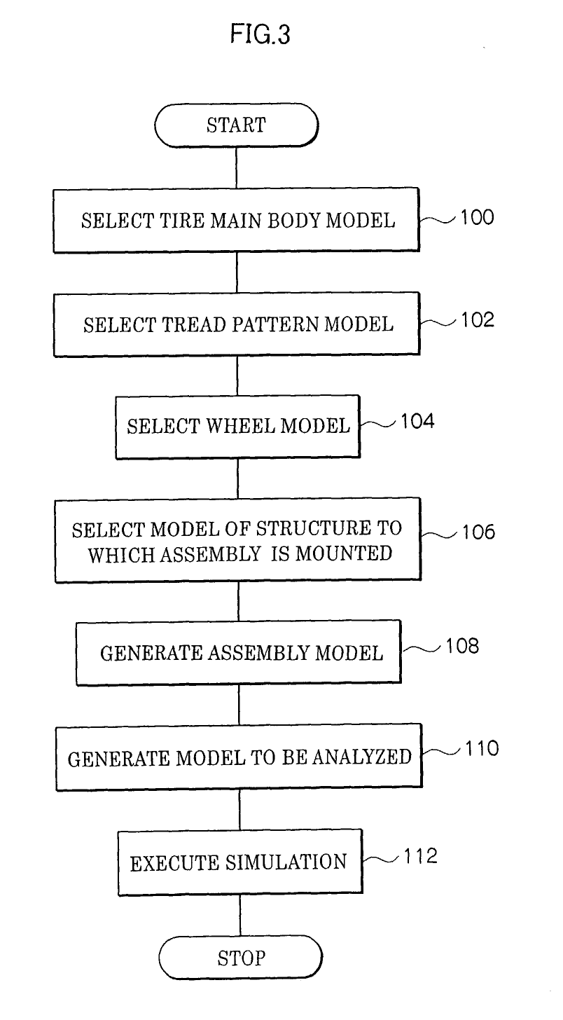

Next, a routine of the processing of the tire performance simulation program will be described with reference to FIG. 3. In step 100, on the basis of data inputted from an operator, one tire-main-body model whose performance is to be analyzed is selected from the plurality of models recorded on the recording medium. In step 102, similarly, one tread pattern model for this tire-main-body model is selected.

In step 104, on the basis of the data inputted from the operator, similarly, one wheel model of the wheel with which the tire is assembled is selected. In step 106, similarly, one mounting object model for mounting the tire-wheel assembly is selected. Any one of the following models, which will be described below, or the like may be selected as the mounting object model:

(1) a suspension model;

(2) combination of two models which are a suspension model and a vehicle body model;

(3) a mechanism analysis model of a vehicle; and

(4) a mechanism analysis model of a suspension.

When tire performance with the tire in a state of ordinary use is analyzed, above (2), which is (combination of) the suspension model and the vehicle body model, is selected. Alternatively, when analyzing tire performance, because the spring constants of the tire itself and the suspension are lower than the elasticity of the vehicle body (the body), the vehicle body can be approximated as a rigid body. Namely, by ignoring the elastic deformation of the vehicle body and treating the vehicle body as a rigid body, even more efficient (i.e., faster) performance estimation is possible. In this case, above (1), which is a suspension model, is selected as the model of the object to which the tire-wheel assembly is mounted.

Further, the spring constants of the tire itself and the suspension springs are lower than the spring constants of the vehicle body and the structural parts of the suspension. Accordingly, more efficient performance estimation can be achieved by ignoring the elastic deformation of the structural parts (of the suspension) themselves, and approximating the structural parts as rigid bodies, and taking only the geometrical movement thereof into consideration. In this case, it is preferable to include, into the analysis model, the parts which contribute to damping such as dampers or bushes or the like. The reason for this is that, not only the tire itself, but also the dampers and the bushes and the like as well greatly contribute to the magnitude of the damping. In this case, above (3), which is a mechanism analysis model of a vehicle, or above (4), which is a mechanism analysis model of a suspension, is selected. Note that above (3) is a modified example of above (2), and in above (3), the vehicle body and the suspension structural parts are considered to be rigid bodies and only the geometrical movement thereof is considered. Above (4) is a modified example of above (1), and in above (4), the suspension structural parts are considered to be rigid bodies and only the geometrical movement thereof is considered.

In subsequent step 108, a tire model is constructed by joining the selected tire-main-body model and tread pattern model, and a “tire-wheel assembly model” is prepared by joining a wheel model to the constructed tire model. In next step 110, the “tire-wheel assembly model” and the mounting object model are joined so as to prepare an analysis object model.

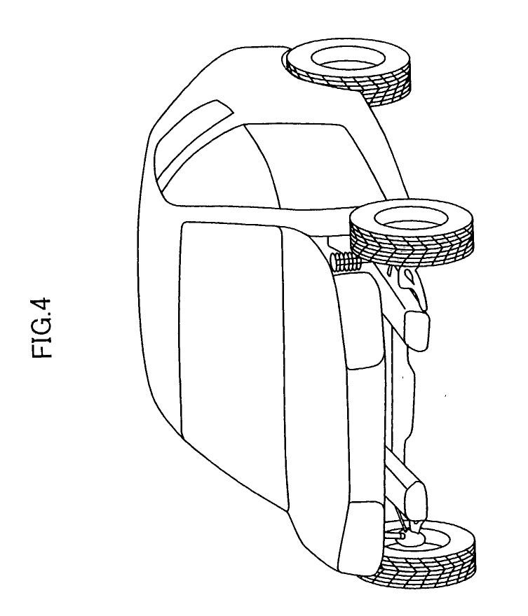

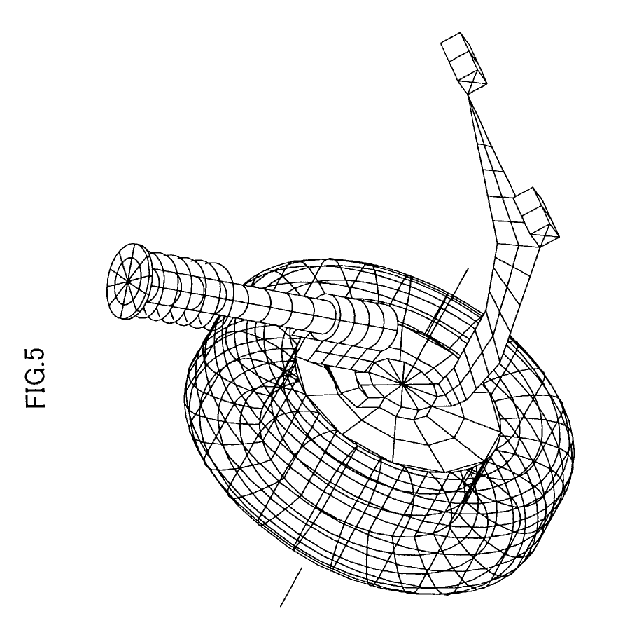

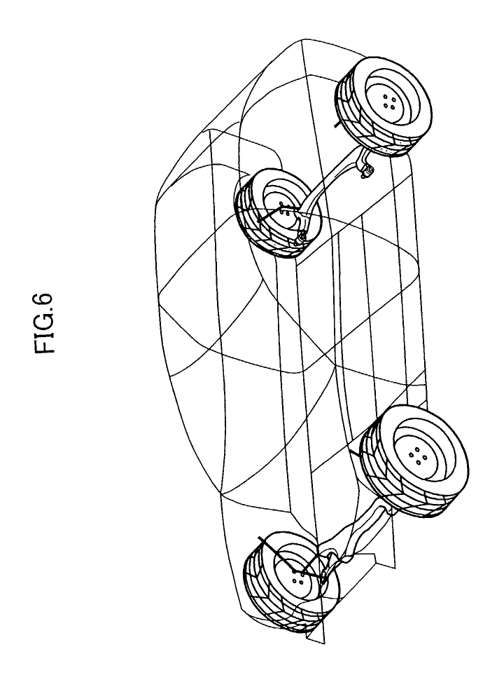

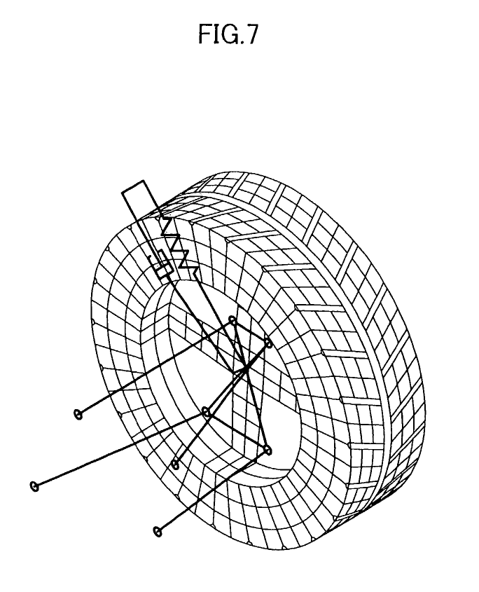

FIGS. 4 through 7 are examples of analysis object models. FIG. 4 shows an analysis object model in which three models are joined, i.e., a vehicle body model and a suspension model (namely, the two models of above (2)) and a “tire-wheel assembly model”. FIG. 5 shows an analysis object model in which a suspension model (i.e., the model of above (1)) and a “tire-wheel assembly model” are joined, without a vehicle body model (without a body model) FIG. 6 shows an analysis object model in which a mechanism analysis model of a vehicle (i.e., the model of above (3)) and a “tire-wheel assembly model” are joined. FIG. 7 shows an analysis object model in which a “tire-wheel assembly model” and a mechanism analysis model expressing a suspension (i.e., the model of above (4)) are joined without a vehicle body model.

The following models can also be used as the analysis object model: a model in which are joined a tire wheel model including a rigid wheel model assembled with a tire model (which tire wheel model will be called model (5) hereinafter) and a suspension model; a model in which are joined the mechanism analysis model of a vehicle of above (3), the suspension model and the “tire-wheel assembly model”; and a model in which are joined three models which are the mechanism analysis model of above (4) expressing a suspension, a vehicle body model, and a “tire-wheel assembly model”.

Next, in step 112, in accordance with a predetermined analysis program, analysis simulation of the performance of four tires is carried out, so that the necessary data is obtained.

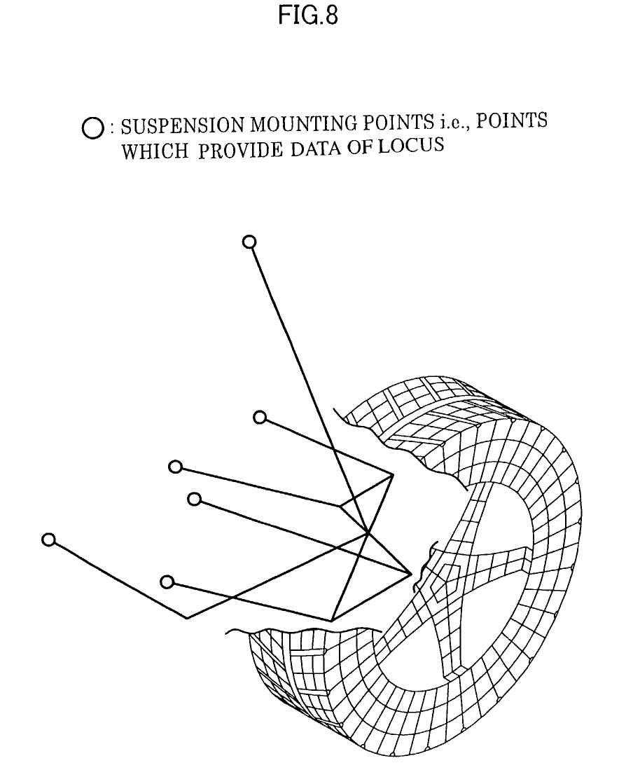

Note that, in the above-described embodiment, efficient and accurate performance estimation of the state in which the vehicle is travelling can be obtained, if the analysis is carried out in detail by the mechanism analysis or the like in which a simple tire model is joined to a vehicle body model, or if analysis is carried out in detail by carrying out testing, extracting from the results thereof a locus of suspension mounting points, and by using this locus, selecting one wheel/one axis of tire and suspension. In this case, for example, as shown in FIG. 8, by using a model in which a suspension model and a “tire-wheel assembly model” are joined without a vehicle body model, the results of mechanism analysis of a vehicle body model and a simple tire model, or the results of analysis of another vehicle, or results of testing can be utilized for the data of the locus of the suspension mounting points. Note that, in FIG. 8, the mark ◯ represents a suspension mounting point, i.e., a point providing locus data.

### EXAMPLES

Hereinafter, Examples of simulating tire performance by using the apparatus for simulating tire performance of the above-described embodiment will be described hereinafter.

(1) The following three types of PSR195/65R15 tires were readied: a tire having only four main grooves; a tire having a caramel pattern in the four circumferential direction grooves; and a tire in which one sipe, in the widthwise direction of the tire, having a width of 0.5 mm and a depth of 5 mm was formed in the center of each block of a caramel pattern in four circumferential direction grooves. For each of the tires, the vertical force at the time of riding-over a cleat of a height of 5 mm and a width of 10 mm was measured or predicted by an indoor test, a test on an actual vehicle, analysis by using a conventional finite element model, and analysis of the present Example using the apparatus for simulating tire performance of the present embodiment, and the respective results were compared.

In the indoor test, the tire was inflated to an internal pressure of 200 kPa, and the tire mounting shaft was fixed to a testing machine in which a cleat was mounted to a drum having a diameter of 3 m. The tire was run under a load of 4.00 kN at a speed of 40 km/h, and the fluctuations in axial force at the time of riding-over the cleat were measured.

In the test on an actual vehicle, the cleat was placed on a flat road surface. The fluctuations in the axial force of a front wheel at the time when the tire passed over the cleat at a speed of 40 km/h were measured.

In the conventional method of analysis, the fluctuations in axial force at the time of riding-over a cleat placed on a flat road surface were obtained by analysis of only a tire assembled with a wheel in which the bead portion of the tire was fixed to a rigid wheel.

In the present Example, the tire wheel model, in which a rigid wheel model was assembled, was joined to an analysis model (suspension model) of a suspension which was the same as in the test on an actual vehicle. The fluctuations in axial force at the time of riding-over the cleat which was placed on a flat road surface were recorded.

The results are shown in Table 1 in which the difference between the greatest and the least of the fluctuations in vertical axial force of each tire type is expressed as an index, with the tire axial force of the tire having only the four main grooves being 100.

TABLE 1

| | Four main | | |
|---|---|---|---|
| | grooves | Caramel pattern | With sipes |
| Indoor test | 100 | 94 | 91 |
| Actual vehicle | 100 | 93 | 90 |
| test | | | |
| Conventional FE | 100 | 96 | 94 |
| analysis method | | | |
| Example | 100 | 93 | 90 |

From the above, it can be seen that, although the indoor test and the conventional Finite Element (FE) analysis method, in which the shafts were fixed and which did not take the suspensions into consideration, tended to exhibit a “tendency” in the results which is similar to that observed in an actual vehicle, there was a significant difference, in the quantitative sense, between the indoor test, the conventional FE analysis method and an actual vehicle. On the other hand, in the (present) Example which included a suspension model, the effects of the pattern was accurately included in the same way as with an actual vehicle.

(2) The following two types of PSR185/70R14 tires were readied: a tire having a caramel pattern in the three circumferential direction grooves; and a tire in which one sipe, in the widthwise direction of the tire, having a width of 0.5 mm and a depth of 5 mm was formed in the center of each block of a caramel pattern in three circumferential direction grooves. The difference between the greatest and the least of the fluctuations in the vertical force at the time when the tires rode-over a cleat of a height of 10 mm and a width of 50 mm at a speed of 60 km/h was obtained by a conventional FE analysis method and present Examples, and the results were compared.

The conventional method of FE analysis was based on the analysis of only a tire mounted to a wheel in which the bead portion of the tire was fixed to a rigid wheel. In the present Examples, the following were carried out: (a) simulation using an FE model (finite element model) in which the three models of a vehicle body model, a suspension model and a “tire-wheel assembly model” were joined; (b) simulation using an FE model in which a suspension model and a “tire-wheel assembly model” were joined without a vehicle body model (without a body model); (c) simulation using an FE model in which a mechanism analysis model expressing a vehicle and a “tire-wheel assembly model” were joined; (d) simulation using an FE model in which a mechanism analysis model expressing a suspension and a “tire-wheel assembly model” were joined without a vehicle body model; and (e) simulation using FE model in which a suspension model and a “tire-wheel assembly model” were joined without a vehicle body model, and using, as the data of the locus of the suspension mounting points, the results of mechanism analysis of a vehicle body model and a simple tire model.

The results of comparing the data obtained by the present Examples with the results of the actual vehicle test are shown in Table 2. How much lower the vertical force of the patterned tire with sipes was than the vertical force of the tire having the caramel pattern without sipes, is expressed by indices in following Table 2, with the vertical force of tire having the caramel pattern without sipes being 100.

TABLE 2

| | |
|---|---|
| Actual vehicle test | 85 |
| Conventional FE model | 93 |
| Analysis method | |
| Example (a) | 85 |
| Example (b) | 88 |
| Example (c) | 86 |
| Example (d) | 89 |
| Example (e) | 87 |

The conventional method of FE analysis was good qualitatively, but poor quantitatively.

The analysis times of the present Examples were as follows, with Example (a) being 100.

TABLE 3

| | |
|---|---|
| Example (a) | 100 |
| Example (b) | 90 |
| Example (c) | 70 |
| Example (d) | 65 |
| Example (e) | 90 |

(3) The following two types of PSR205/50R16 tires were readied: a tire having a caramel pattern in four grooves and whose number of pitches in the circumferential direction was 40; and a tire having a caramel pattern in four grooves and whose number of pitches in the circumferential direction was 60. A constant circle turning (50R) test was carried out while gradually increasing the speed from 10 km/h. The vehicle roll angle at the time when 0.5 G was generated was obtained by the test on an actual vehicle and present Examples, and these results were compared.

In the present Examples, simulation of the following two analysis models was carried out: (a) FE model in which the three models of a vehicle body model, a suspension model and a “tire-wheel assembly model” were joined; and (b) FE model in which a mechanism analysis model expressing a vehicle and a “tire-wheel assembly model” were joined.

The results of analysis are shown in following Table 4 as indices with the results of the tire, of the actual vehicle test, which had a caramel pattern and a number of pitches of 60, being 100.

TABLE 4

| | Number of pitches: 60 | Number of pitches: 40 |
|---|---|---|
| Actual vehicle | 100 | 90 |
| Example (a) | 100 | 90 |
| Example (b) | 98 | 91 |

(4) The following two types of PSR235/70R16 tires were readied: a tire having a caramel pattern in four grooves; and a tire in which two sipes, in the widthwise direction of the tire, and one sipe, in the circumferential direction, each sipe having a width of 0.5 mm and a depth of 5 mm, were formed in the center of each block of a caramel pattern in the four circumferential direction grooves. The noise within the vehicle at a position near the head of the driver, when the vehicle was driven straight on a road surface (such as a road for testing road noise) in which ¾ of a 10 mm-diameter sphere was embedded into a flat road surface at a density of one embedded sphere per 4 cm² (namely, a road surface in which ¼ of a 10 mm-diameter sphere projected above the road surface at a density of one embedded sphere per 4 cm²), was obtained by both an actual vehicle test and by present Examples, and the results were compared.

This simulation cannot be carried out by a conventional analysis method of only a tire model. Further, in the present Examples, the following were carried out: (a) FE model simulation in which were joined the three models of a vehicle body model, a suspension model and a “tire-wheel assembly model”; (b) a simulation utilizing an FE model in which a suspension model and a “tire-wheel assembly model” were joined without a vehicle body model (without a body model); and (c) simulation utilizing a FE model in which a mechanism analysis model expressing a vehicle and a “tire-wheel assembly model” were joined.

The results of comparing the results of the present Examples with the results of the actual vehicle are shown in Table 5. How much lower the in-vehicle noise of the patterned tire with sipes was than that of the tire with the caramel pattern, is expressed by indices in following Table 5, with the in-vehicle noise of the tire with the caramel pattern being 100.

TABLE 5

| | |
|---|---|
| Actual vehicle | 90 |
| Example (a) | 90 |
| Example (b) | 92 |
| Example (c) | 91 |

Further, the analysis times of the present Examples were as follows, with Example (a) being 100.

TABLE 6

| | |
|---|---|
| Example (a) | 100 |
| Example (b) | 90 |
| Example (c) | 70 |

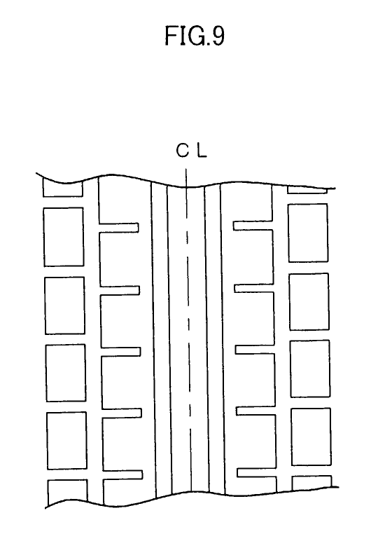

(5) Two types of PSR205/55R16 tires having pitch lengths of 35 mm and 40 mm, respectively, were subjected to lane change tests. The time until the fluctuations in the yaw rate converged were obtained by both the actual vehicle test and the present Examples and were compared. The tread pattern of the tires which were used is shown in FIG. 9. Note that the one-dot chain line CL in FIG. 9 is the center line of the tire. Only the pitch lengths of the patterns of the two types of tires were different, and the sectional surface areas, structures, and rubbers thereof were exactly the same.

In the actual vehicle test, the tire was mounted to a 6.5×16 rim and was inflated to an air pressure of 220 kPa. Further, a sine-wave-like steering input was applied to the lane change. The steering angle of the sine-wave was 50° (amplitude), the period was 2 seconds, and the vehicle speed was 60 km/h.

An actual tire-wheel steering angle (rudder angle) of 50° was inputted as the amplitude of the sine-wave to the tire performance simulating apparatus of the present invention. For the other conditions (rim size, tire air pressure, period of the sine-wave, vehicle speed, and the like), conditions which were the same as those of the test on an actual vehicle were inputted. Note that, in a conventional FE analysis method, it is impossible to input such complex conditions and carry out analysis.

Further, in Example (a), FE model simulation was carried out in which the three models of a vehicle body model, a suspension model and a “tire-wheel assembly model” were joined. In Example (b), FE model simulation, in which a mechanism analysis model expressing a vehicle and a “tire-wheel assembly model” were joined, was carried out.

The results of simulation are shown in Table 7 in comparison with the results of an actual vehicle. The time until the yaw rate fluctuations of the tire of a pitch length of 40 mm converged is expressed as an index, with the time until the yaw rate fluctuations of the tire of a pitch length of 35 mm converged being 100.

TABLE 7

| | |
|---|---|
| Actual vehicle | 95 |
| Example (a) | 95 |
| Example (b) | 96 |

Further, the analysis times of the present Examples were as follows, with Example (a) being 100.

TABLE 8

| | |
|---|---|
| Example (a) | 100 |
| Example (b) | 90 |

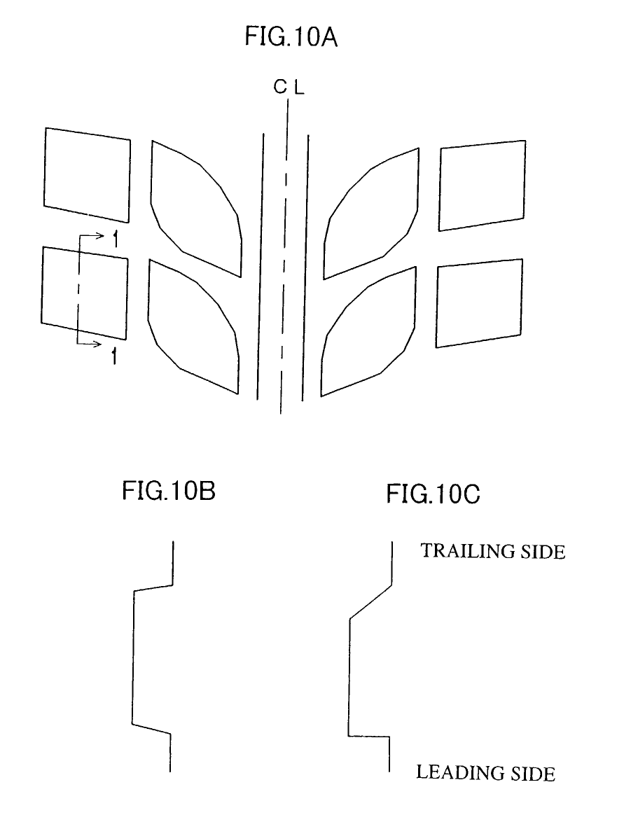

(6) Braking tests were carried out on two types of PSR205/55R16 tires which had directionality and whose patterns of the tread surfaces were the pattern shown in FIG. 10A (where CL is the center line of the tire). The braking distances were obtained by a test on an actual vehicle and by present Examples, and were compared. Of the two types of tires, in one tire, as shown in FIG. 10B, the angle formed by the wall surface of the block and the tread surface was 84° at both the leading side and the trailing side. In the other tire, as shown in FIG. 10C, the angle formed by the wall surface of the block and the tread surface was 81° at the trailing side and 87° at the leading side.

In the test on an actual vehicle, the tires were mounted to 6.5J×16 rims and inflated to an air pressure of 220 kPa. The antilock brake system (ABS) of the vehicle was operated so as to brake the vehicle. In the simulation of the present Examples, the slip rate of the tire with respect to the road surface was set to 10%, and the same conditions as those of the actual vehicle test were inputted for the other conditions (the rim size, the tire air pressure, and the like), for the braking simulation. Note that, in a conventional analysis method, it is impossible to input such complex conditions for analysis. Specifically, braking force and fluctuations in load generally arise due to the braking. However, in the conventional method of analyzing the tire alone, it is not possible to analyze a state in which the vehicle decelerates by also taking such parameters (braking force and fluctuations in load) into consideration. Further, analysis carried out by using only the results of ADAMS analysis will result in insufficient compounding. Thus, according to the conventional analysis method, it is not possible to appropriately analyze a state in which the vehicle decelerates while braking force is generated.

Further, in Example (a), FE model simulation in which three models, which were a vehicle body model, a suspension model, and a “tire-wheel assembly model”, were joined, was carried out. In Example (b), FE model simulation, in which a mechanism analysis model expressing a vehicle and a “tire-wheel assembly model” were joined, was carried out.

The results of the simulations and the results obtained with an actual vehicle are shown in comparison in Table 9. The braking distance of the tire in which the angle formed by the wall surface of the block and the tread surface was 81° at the trailing side and 87° at the leading side was expressed as an index, with the braking distance of the tire in which the angle formed by the wall surface of the block and the tread surface was 84° at both the leading side and the trailing side being 100.

TABLE 9

| | |
|---|---|
| Actual vehicle | 95 |
| Example (a) | 95 |
| Example (b) | 96 |

Further, the analysis times of the present Examples were as follows, with Example (a) being 100.

TABLE 10

| | |
|---|---|
| Example (a) | 100 |
| Example (b) | 80 |

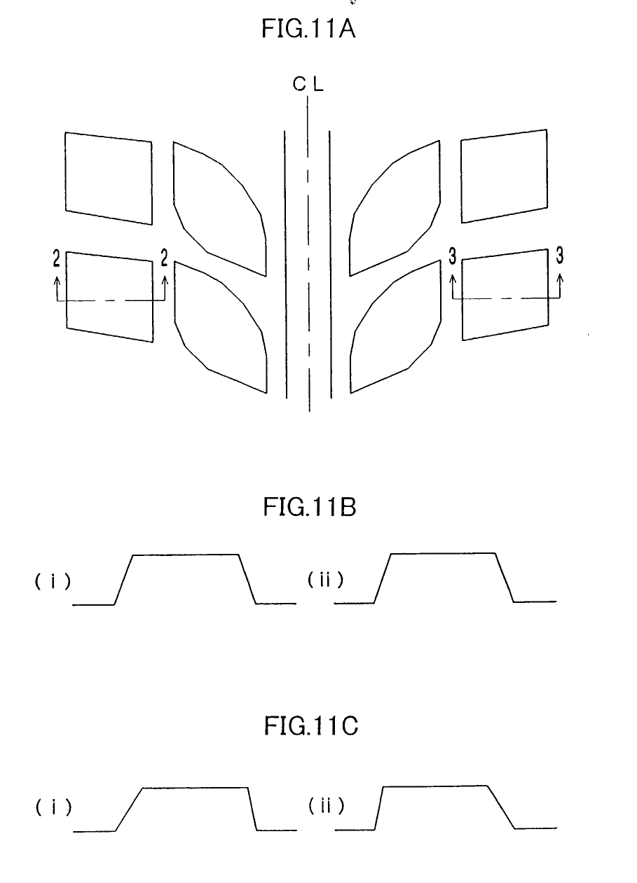

(7) A test for determining the roll angle of the vehicle body while turning in a constant circle was carried out on two types of PSR205/55R16 tires which had directionality and whose patterns of the tread surfaces were the pattern shown in FIG. 11A (where CL is the center line of the tire). The roll angle of the vehicle body was obtained by a test on an actual vehicle and by the present Examples, and these results were compared. Of the two types of tires, in one tire, as shown in FIG. 11B, the angle formed by the wall surface of the block and the tread surface was 84° at both of the inner side and the outer side in the widthwise direction of the tire. In the other tire, as shown in FIG. 11C, the angle formed by the wall surface of the block and the tread surface was 81° at the outer side in the widthwise direction of the tire and 87° at the inner side in the widthwise direction of the tire.

In the test on an actual vehicle, the tires were mounted to 6.5×16 rims and inflated to an air pressure of 220 kPa. The vehicle was turned in a constant circle of a radius of 40 m while varying the speed, and the roll angle of the vehicle body at the time when the gravitational acceleration in the lateral direction was 0.2 G was determined. The roll angles of the vehicle body were also determined by inputting the same conditions (rim size, tire air pressure, radius of the circle, gravitational acceleration in the lateral direction, and the like) as those obtained in the actual vehicle test to the tire performance simulation apparatus. Note that, in a conventional analysis method, it is impossible to input such complex conditions and carry out analysis. Specifically, cornering force and fluctuations in load generally arise due to the cornering. However, in the conventional method of analyzing the tire alone, it is not possible to analyze a state in which the vehicle moves by also taking such parameters (cornering force and fluctuations in load) into consideration. Further, analysis carried out by using only the results of ADAMS analysis will result in insufficient compounding. Thus, according to the conventional analysis method, it is not possible to analyze changes in vehicle body behavior caused by cornering force.

Further, in Example (a), FE model simulation in which three models, which were a vehicle body model, a suspension model, and a “tire-wheel assembly model”, were joined, was carried out. In Example (b), FE model simulation in which a mechanism analysis model expressing a vehicle and a “tire-wheel assembly model” were joined, was carried out.

The results of the simulations and the results obtained with an actual vehicle are shown in comparison in Table 11. The vehicle body roll angle of the tire in which the angle formed by the wall surface of the block and the tread surface was 81° at the outer side in the widthwise direction of the tire and 87° at the inner side in the widthwise direction of the tire was expressed as an index, with the vehicle body roll angle of the tire in which the angle formed by the wall surface of the block and the tread surface was 84° at both inner and outer sides in the widthwise direction of the tire, being 100.

TABLE 11

| | |
|---|---|
| Actual vehicle | 96 |
| Example (a) | 96 |
| Example (b) | 95 |

Further, the analysis times of the present Examples were as follows, with Example (a) being 100.

TABLE 12

| | |
|---|---|
| Example (a) | 100 |
| Example (b) | 85 |

As described above, in accordance with the present invention, a numerical computational model is prepared by producing a model for each individual part and combining these models. Thus, even a large-scale model can be constructed easily in a short period of time, and the patterns can be changed easily. Further, the performance of the tire in a state in which the tire is in use can be accurately simulated.

What is claimed is:

1. A method of simulating tire performance, comprising the steps of:
(a) preparing a tire model by dividing a patterned tire, which includes a pattern formed from a plurality of land portions, into plural parts, and by expressing each part by a part model formed from a large number of divisional elements, and by combining a plurality of the part models;
(b) expressing a suspension as a suspension model formed from a large number of divisional elements; and
(c) analyzing performance of the patterned tire in a state in which the patterned tire is in use, by using, as one numerical computational model, a first numerical computational model including the tire model and a second numerical computational model including the suspension model.

2. An apparatus for simulating tire performance, comprising:
first storing means for storing a first numerical computational model and a second numerical computational model, the first numerical computational model including a tire model prepared by dividing a patterned tire, which includes a pattern formed from a plurality of land portions, into plural parts, and by expressing each part by a part model formed from a large number of divisional elements, and by combining a plurality of the part models, and the second numerical computational model including a suspension model which expresses a suspension as a model formed from a large number of divisional elements;
second storing means for storing a program for analyzing performance of the patterned tire in a state in which the patterned tire is in use; and
analyzing means for analyzing, in accordance with the program, performance of the patterned tire in a state in which the patterned tire is in use by using, as one numerical computational model, the first numerical computational model and the second numerical computational model stored in the first storing means.

3. A recording medium readable by a computer, wherein
a first numerical computational model including a tire model prepared by dividing a patterned tire, which includes a pattern formed from a plurality of land portions, into plural parts, and by expressing each part by a part model formed from a large number of divisional elements, and by combining a plurality of the part models;
a second numerical computational model including a suspension model which expresses a suspension as a model formed from a large number of divisional elements; and
a program for analyzing performance of the patterned tire in a state in which the patterned tire is in use by using, as one numerical computational model, the first numerical computational model and the second numerical computational model, are recorded on the recording medium.

4. A method of simulating tire performance, comprising the steps of:
(a) preparing a tire model by dividing a patterned tire, which includes a pattern formed from a plurality of land portions, into plural parts, and by expressing each part by a part model formed from a large number of divisional elements, and by combining a plurality of the part models;
(b) preparing a wheel model which expresses a wheel as a part model formed from a large number of divisional elements;
(c) preparing a suspension model which expresses a suspension as a suspension model formed from a large number of divisional elements;
(d) preparing a model of a tire-wheel assembly by combining the wheel model with the tire model; and
(e) analyzing performance of the patterned tire in a state in which the patterned tire is in use, by using, as one numerical computational model, a first numerical computational model including the tire-wheel assembly and a second numerical computational model including the suspension model.

5. The method of simulating tire performance of claim 4, wherein in the step (a), plural tire models of different types are prepared and in the step (b), plural wheel models of different types are prepared, and in the step (d), the model of a tire-wheel assembly is prepared by combining a wheel model selected from the plural wheel models with a tire model selected from the plural tire models.

6. A method of simulating tire performance, comprising the steps of:
(a) preparing a tire model by dividing a patterned tire, which includes a pattern formed from a plurality of land portions, into plural parts, and by expressing each part by a part model formed from a large number of divisional elements, and by combining a plurality of the part models;
(b) preparing a wheel model which expresses a wheel as a part model formed from a large number of divisional elements;
(c) preparing a suspension model which expresses a suspension as a suspension model formed from a large number of divisional elements;
(d) preparing a vehicle body model which expresses a vehicle body as a part model formed from a large number of divisional elements;
(e) preparing a model of a tire-wheel assembly by combining the wheel model with the tire model; and
(f) analyzing performance of the patterned tire in a state in which the patterned tire is in use, by using, as one numerical computational model, a first numerical computational model including the tire-wheel assembly and a second numerical computational model obtained by combining the suspension model with the vehicle body model.

7. The method of simulating tire performance of any of claims 1, 4, 5 and 6, wherein the step (a) of preparing a tire model including the steps of: dividing a patterned tire into two parts, which are a pattern part and a tire-main-body part as a tire part other than the pattern part, and by expressing each part by apart model formed from a large number of divisional elements, and by combining the two part models.

8. The method of simulating tire performance of claim 7, wherein the step (a) including the steps of: preparing plural part models of different types of the tire-main-body part; preparing plural part models of different types of the pattern part; and preparing the tire model by combining a part model selected from the plural part models of the tire-main-body part, with a part model selected from the plural part models of the pattern part.

9. The method of simulating tire performance of claim 7, wherein the step (a) including the steps of: preparing a standard model as the part model of the tire-main-body part; preparing plural part models of different types of the pattern part; and preparing the tire model by combining the standard part model of the tire-main-body part, with a part model selected from the plural part models of the pattern part.

10. The method of simulating tire performance of any of claims 1, 4 to 9, wherein in the step of preparing a suspension model, plural suspension models of different types are prepared, and in the step of analyzing tire performance, the one numerical computational model is produced by combining the first numerical computational model with the second numerical computational model as a suspension model selected from the plural suspension models.

11. The method of simulating tire performance of any of claims 6 to 10, wherein in the step of preparing the vehicle body model, plural vehicle body models of different types are prepared, and in the step of analyzing tire performance, the one numerical computational model is produced by combining the first numerical computational model with the second numerical computational model as a combination of the suspension model and a vehicle body model selected from the plural vehicle body models.

12. The method of simulating tire performance of any of claims 6 to 11, wherein, in the vehicle body model, the vehicle is considered to be a rigid body.

13. The method of simulating tire performance of any of claims 4 to 12, wherein, in the wheel model, the wheel is considered to be a rigid body.

14. The method of simulating tire performance of any of claims 1, 4 to 13, wherein the second numerical computational model includes a model selected from the group consisting of the suspension model, a model as the combination of the suspension model and the vehicle body model, a mechanism analysis model of a vehicle which considers a vehicle body and a suspension to be rigid bodies, and which takes only geometric movement of the rigid bodies into consideration, and a mechanism analysis model of a suspension which considers a suspension to be a rigid body, and which takes only geometric movement of the rigid body into consideration.

15. The method of simulating tire performance of any of claims 1, 4 to 14, wherein fluctuations in axial force at the time of riding-over the cleat, fluctuations in axial force in the vertical direction at the time of riding-over the cleat, a test of turning in a constant circle, a noise within a vehicle at a position near the head of the driver, when the vehicle was driven straight on a road surface for testing road noise, a lane change test, a braking test of the tire, or a test for determining the roll angle of the vehicle body while turning in a constant circle, are simulated.
